(19) United States
(12) Patent Application Publication
(10) Pub. No.: US 2010/0218834 A1
(43) Pub. Date: Sep. 2, 2010

(54) MICRO FLUID DEVICE WITH A MULTI LUMEN HOSE

(75) Inventors: Per Brandt Rasmussen, Augustenborg (DK); Peter Gravesen, Augustenborg (DK)

Correspondence Address: MCCORMICK, PAULDING & HUBER LLP, CITY PLACE II, 185 ASYLUM STREET, HARTFORD, CT, 06103, US

(73) Assignee: Diramo A/S, Nordborg (DK)

(21) Appl. No.: 12/524,896

(22) PCT Filed: Jan. 30, 2007
(86) PCT No.: PCT/DK07/00044

§ 371 Date: Apr. 29, 2010

(51) Int. Cl. F16L 3/01

(52) U.S. Cl. 137/561 R

(57) ABSTRACT

The invention provides a micro fluid device comprising a substrate with a channel forming a receiving cavity, an outer chamber, and an inner chamber, the device further comprising a multi lumen hose with a free end portion which is fixed in the receiving cavity. The multi lumen hose forming a first conduit and at least one second conduit located radially offset from the first conduit, and the outer chamber is in fluid communication with at least one second conduit, and the inner chamber is in fluid communication with the first conduit. The chambers are separated by an inner sealing member located between the substrate and the hose. To simplify the manufacturing of the device, the channel is formed by a groove in an upper surface of a body of the substrate, which groove closed by an essentially plane cover which is sealed to the upper surface.

### CROSS REFERENCE TO RELATED APPLICATIONS

This application is entitled to the benefit of and incorporates by reference essential subject matter disclosed in International Patent Application No. PCT/DK2007/000044 filed on Jan. 30, 2007.

### TECHNICAL FIELD

The present invention relates to a micro fluid device comprising a substrate with a channel forming a receiving cavity, an outer chamber, and an inner chamber. The device further comprises a multi lumen hose with a free end portion which is fixed in the receiving cavity. The multi lumen hose forms a first conduit and at least one second conduit located offset from the first conduit, wherein the outer chamber is in fluid communication with at least one second conduit, and the inner chamber is in fluid communication with the first conduit and wherein the chambers are separated by an inner sealing member which seals between the substrate and the hose.

### BACKGROUND OF THE INVENTION

In Microsystems engineering, various processes are applied for connecting components. The processes generally involve cementing two surfaces together. To make a fluid tight connection, the parts must be fitted accurately to each other prior to the application of the cement, and obviously, proper contact between the cement and both of the surfaces which are to be joined without unintentional clogging of fluid paths is important. Particularly difficult is to connect hoses, fibres or similar flexible and relatively thin components to other components, e.g. to a fluid chip or similar substrate. In this case, it is not only important to establish fluid tightness but also to preserve the fixation of the parts over time, even when the flexibility of one of the components implies movement of the components relative to each other.

A multi lumen hose contains in one single unit, a plurality of separate conduits. Typically a centrally located first conduit is surrounded by at least one second conduit. The conduits sometimes extend coaxially so that each conduit share the same centre axis or the second conduits are located as cartridge chambers in a revolver with individual centre axes for each conduit.

Often, the conduits communicate with different chambers of the cooperating substrate. For this purpose, the hose of the existing systems are prepared for communication at two axially displaced locations. At a free end of the hose, the centrally located conduit is laid open, and before connection of the hose to the substrate, an outer portion of the hose is stripped so as to open the second conduits at a certain distance from the free end of the hose. The stripping of the hose unfortunately creates a diametric reduction of the hose, and the receiving cavity of the corresponding substrate therefore has a corresponding cross-sectional dimensional step. I.e. the substrate comprises a step between a first cross sectional size which snugly fits around the stripped portion of the hose and a second cross sectional size which snugly fits around the un-stripped portion of the hose. As previously mentioned, it is important that the bonding cement establishes contact between the outer surface of the hose and the inner surface of the groove, and it is important that the cement does not clog the chambers. It is therefore important that the dimensional tolerances between the substrate and the hose are low and the stepped shape of the groove is therefore relatively expensive to provide. In the known devices the substrate is made from an upper part and a lower part which both have a step corresponding to half of the total diametric reduction of the hose. When the two parts are assembled, the receiving cavity matches the shape of the hose precisely. Due to the combination of two parts which both have a structure which must match the structure of the other part, both the manufacturing of the two parts and the assembling of the parts are relatively expensive processes.

One document WO 2005/102005 discloses a catheter manifold being molded about a portion of an outer tubular member and a portion of an inner tubular member of a catheter. With reference to FIG. 7, a molding material, for example a molten molding material, is described being introduced and/or injected into a mold cavity 70 through a port 80 to form the manifold 22. Generally, the entire mold cavity is filled with the molding material.

After introduction of the molding material, the material is allowed to cure, thereby forming the manifold 22. After the manifold 22 is formed and cured sufficiently, the mold 62 may be removed and other steps in the process of fabrication performed. Again, it should be noted that the proximal end 35 of the inner tubular member 30 extends proximally from the proximal end 37 of the outer tubular member 32. As such, both the inner and outer tubular members 30/32 are attached to the manifold 22. The inner tubular member is attached by virtue of having the inner tubular member 30 extend beyond the proximal end of the outer tubular member 32.

The document therefore only describes a process of molding a manifold to a catheter, the mold being removed from the final product, and not attaching a multi lumen hose to a micro fluid device comprising a substrate with a channel forming a receiving cavity, an outer chamber, and an inner chamber, where the micro fluid device forms part of the final product.

Another document US 2009/0041624 describes a fluidic structure and a method for production of a fluidic structure. The method may comprise, in order, introducing at least one externally accessible opening into at least one base substrate of the fluidic structure, partially introducing at least one section of a fluidic conductor, which has at least one inner lumen and at least one conductor wall, in particular of a tube or flexible tube, into the at least one opening, introducing at least one curable fluid sealing material into the at least one opening, entirely or partially curing the at least one fluid sealing material, and producing at least one connecting channel between at least one inner lumen in the at least one fluidic conductor and at least one fluid channel in the fluidic structure, the at least one connecting channel passing through at least one conductor wall.

The sealing material introduced in this document, however, is seen filling the space of the at least one opening around the at least one section of a fluidic conductor, the at least one connecting channel this passing not only through at least one conductor wall, but also the sealing material. The present invention introduces a method to avoid such a connecting channel passing through conductor wall and sealing material.

### SUMMARY OF THE INVENTION

It is an object of the invention to facilitate assembling of a multilumen hose and a substrate. Accordingly, the invention, in a first aspect, provides a micro fluid device wherein at least a part of the channel is formed by a groove in an upper surface of a body of the substrate, which groove is closed by an essentially plane cover which is sealed to the upper surface.

The substrate may e.g. be a fluid chip, e.g. a chip comprising a plurality of micro channels. The chip could be made from silicon or from a polymer, and the channels could be made mechanically by a cutting tool or chemically in an etching process. If the chip is made from a polymer, the channels could be made by hot embossing by pressing a heated metal or silicon die into the polymer material. The Channels may e.g. be micro channels with a cross-sectional area in the range of 20-500 μm. The receiving cavity may preferably fit closely around the hose, and for any axial location along the free end portion of the hose, the cross-sectional size of the receiving cavity could therefore be in the range of 101-130% of the cross-sectional size of the hose. In particular, a close fit between the cavity and the hose may facilitate tight sealing since a liquid sealing member may flow into correct position between the cavity and the hose due to surface tension or capillary force. The closer the hose is to the wall of the cavity, the lower a viscosity is preferred for the liquid sealing member.

The upper surface of the body could be a plane surface to which the plane cover is attached, e.g. adhesively or the cover could be welded onto the surface e.g. by ultrasonic welding. The cover could be made from a foil material, e.g. with a thickness of 20-1000 μm. Preferably, the cover is highly flexible, so that the essentially plane shape appears when the cover is applied to the plane upper surface of the body part. The hose could form any number of conduits, e.g. one centre conduit and tree, four, five or more conduits arranged circumferentially around the centre conduit. The hose could be made from one single piece in which the conduits extends, e.g. an extruded piece. Alternatively, the hose could contain a number of individual hoses which are all surrounded by an outer hose, i.e. like power cords in a power cable. The hose could e.g. be made from PTFE or PVC, e.g. from the company Zeus Industrial Products Inc. (c.f. http://www.zeusinc.com/) or from Medical Tubing SAS (c.f. http://www.medical-tubing.com/).

To bond the cover to the body part, the cover and the body part are prepared to have essentially plane matching surfaces. The two parts are located with the matching surface in mutual contact, and the parts are arranged in a fixture. Subsequently, the parts are welded in a manner known per se. If the parts are made from a polymer, laser welding may be applied in a manner known per se. If the parts are made form silicon, electrostatic bonding may be applied in a manner known per se.

That the surfaces such as that the cover are essentially plane, is to be understood in the sense were they comprises a main surface being plane for matching a second essential plane surface, but where shapes such as rifts or grooves may be shaped in the surfaces. In this manner, the essential plane cover may e.g. comprise grooves mirrored to the ones formed in the upper surface of the substrate. There may also be dowels and holes formed in the surface of the cover and the upper surface of the substrate to ensure that they align sufficiently.

The channels may e.g. have a depth into the body which corresponds to the thickness of the hose. In that way, a part of the hose is in plane with the upper surface, and the cover may bond not only to the upper surface but also to the hose.

The inner sealing member is located between the opening into the first conduit and the opening into the second conduits whereby it seals between the two chambers which communicate with the hose. The device may further comprise an outer sealing member which seals between the substrate and the hose at a location wherein the hose is not stripped, i.e. between the surrounding space and the outer chamber, and the outer sealing member thereby separates the outer chamber from a surrounding space.

The sealing members could be made from a liquid material which is introduced into the space between the receiving cavity and the hose and solidified therein. As an example, the sealing member could be made from a liquid polymeric material which can be solidified and which may bond to the cover, to the body part and to the hose. The liquid material could be introduced through an opening in the cover and subsequently be solidified therein. The solidification process may e.g. involve curing, e.g. based on electron beam or electromagnetic radiation.

To support the moulding of the liquid material directly into the receiving cavity, and to fixate the hose against axial displacement in the receiving cavity, the receiving cavity may form one or more sealing wells in which the cross-sectional size of the receiving cavity widens out. In that way, the area of contact between the sealing member and the inner wall of the receiving cavity may increase without increasing the axial length of the sealing member, and the liquid tightness and strength of the connection can be improved without increasing the risk of clogging the inner and outer chambers.

In one embodiment, the second conduits are formed by a peripheral outer portion of the hose, e.g. located radially offset from a centrally located first conduit. The outer portion is stripped off to open the second conduits at a location at a distance from the free end of the hose. At an intermediate location between the free end and the stripped portion, the outer portion is not removed and the inner sealing member is moulded onto this intermediate portion so that the sealing member seals between the outer surface of the outer portion and the wall of the receiving cavity. In this embodiment, the second conduits may be sealed individually by an internal sealing member to prevent communication between the inner and outer chamber through the second conduits. The inner sealing member could e.g. be a liquid material which is solidified in the second conduits.

In one embodiment, the outer portion of the hose is stripped off to open the second conduits at two locations at two different distances from the free end of the hose. The inner sealing member is located to seal between the inner surface of the receiving cavity and a proximal stripped off portion, i.e. the portion closest to the free end of the hose. When the hose is located in the receiving cavity, the proximal stripped off portion may serve as a mould for moulding the inner sealing member directly into the space between the hose and the receiving cavity.

To support the hose in the receiving cavity and to improve the tightness of the connection, the receiving cavity may form an inner portion with a smaller cross sectional size than the remainder portion of the receiving cavity. This allows the stripped off portion of the hose to be located in the inner portion of the receiving cavity and the un-stripped portion to be located in the remainder portion of the receiving cavity so that the distance from the inner wall of the receiving cavity and the hose is essentially constant.

To increase the length along which the hose is in contact with the wall of the receiving cavity, the receiving cavity may extend at an angle different from zero degrees to the cover. The receiving cavity could e.g. be drilled into the substrate, e.g. at 45 degrees angle to a plane defined by the essentially plane cover or to a plane defined by the upper surface of the substrate. At the bottom of the drilled bore hole, communication may preferably be provided into the inner chamber, and at a distance from the bottom of the drilled bore hole, communication could be provided to the outer chamber. The inner and the outer chambers could be provided as grooves in the upper surface which grooves are sealed by the cover.

In one embodiment, the receiving cavity forms an obstruction which limits the insertable length of the hose in the receiving cavity. The obstruction could be any kind of protrusion on the inner surface of the receiving cavity, or the receiving cavity may at a certain point be confined to prevent the hose from entering.

In a second aspect, the invention provides a method of connecting a multi lumen hose in a substrate. The method comprising: providing a substrate with an essentially plane upper surface. Providing an essentially plane cover, locating the hose in a receiving cavity which is in contact with grooves provided in the upper surface, and closing the grooves by attaching the cover to the upper surface. The method may further comprise any step related to the provision of a device according to the first aspect of the invention.

### BRIEF DESCRIPTION OF DRAWINGS

In the following, the invention will be described in further details with reference to the drawing in which:

FIGS. 1 and 2 illustrate a connection between a hose and a substrate in accordance with the invention, and

FIGS. 3-13 illustrate various alternative embodiments of connections according to the invention.

### DETAILED DESCRIPTION OF THE PREFERRED EMBODIMENTS

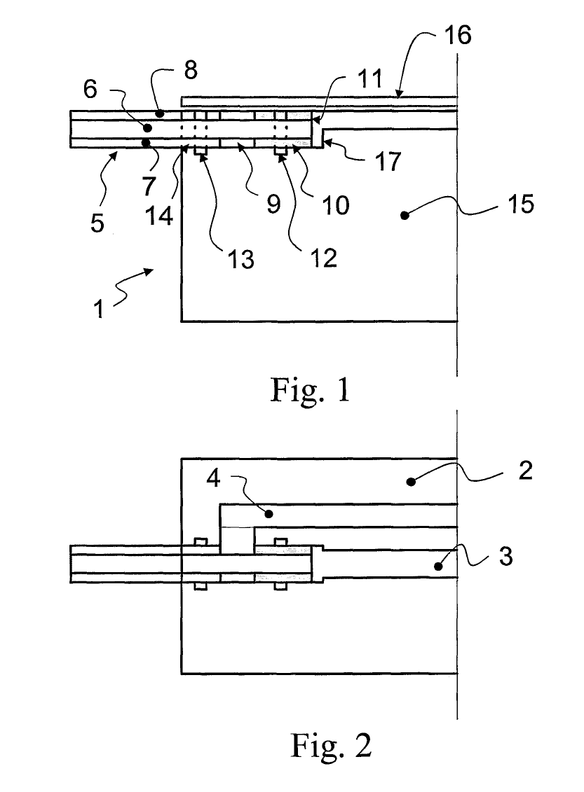

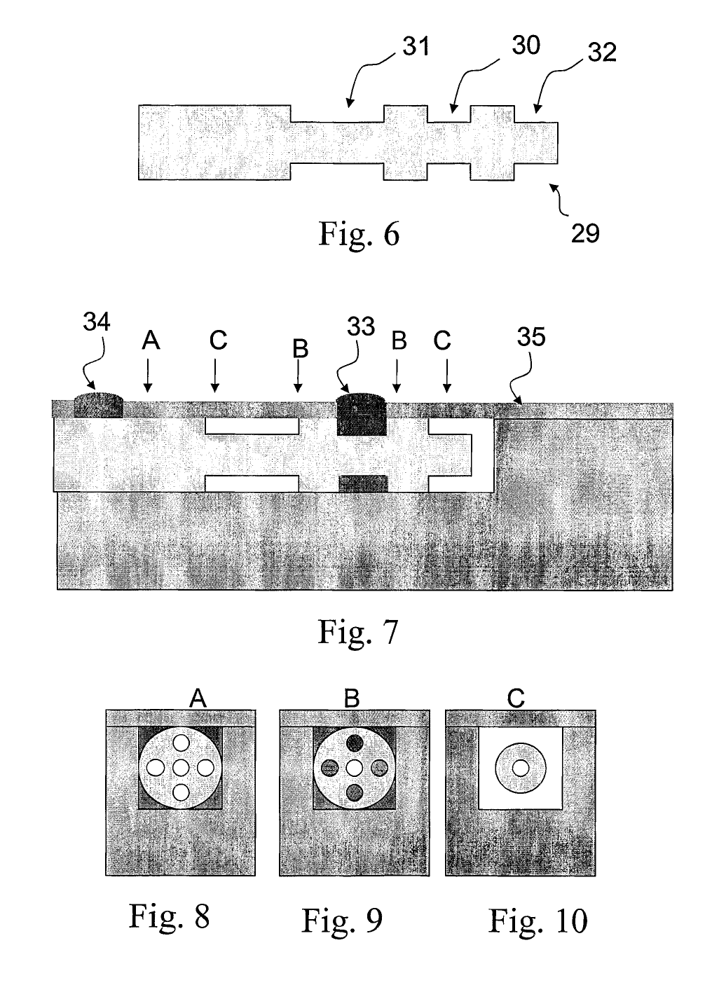

FIG. 1 illustrates a device according to the invention in a cross sectional side view, and FIG. 2 shows the devise without the cover and seen in a top view. The substrate 1 comprises a plane upper surface 2 in which two grooves form an inner chamber 3 and an outer chamber 4. A multi lumen hose 5 with a first conduit 6 and two second conduits 7, 8, is located in a receiving cavity of the substrate. The hose comprises a stripped distal portion 9 and an un-stripped portion 10 located between the stripped distal portion 9 and the free end 11. Correspondingly, the receiving cavity comprises a wide section and a narrow section for accommodating the un-stripped portion 9 and the stripped portion 10, respectively. An inner sealing well 12 supports moulding of an inner sealing member between the inner surface of the receiving cavity and the outer surface of the stripped portion of the hose, and an outer sealing well 13 correspondingly supports moulding of an outer sealing member. The inner sealing member is located at an un-stripped portion 10 of the hose while the outer sealing member is located at the un-stripped portion 14 of the hose. The substrate is made from a body part 15 and a cover part 16, and to match the stepped configuration of the hose at the transition between the stripped portion 9 and the un-stripped portion 10, both the body part 15 and the cover part 16 comprises an embossed, steeped, configuration. The body part 15 is embossed and forms the step 17. The cover 16 is attached to the upper surface and thus closes the grooves and thereby the inner and outer chambers. Sealing members can be moulded into the wells 12, 13 through one or more openings through the cover (the openings are shown e.g. in FIG. 6.

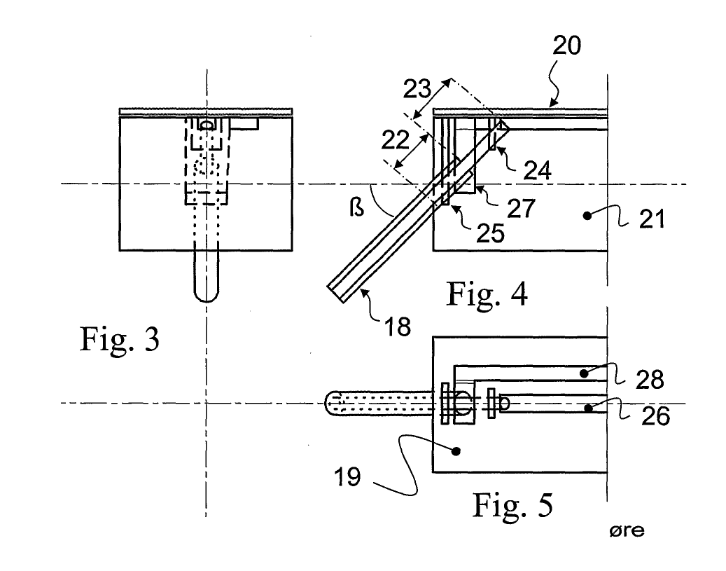

FIGS. 3 and 4 illustrate in cross-sectional side views, an alternative device according to the invention, and FIG. 5 shows a top view of the same device without the cover. The hose 18 extends at an angle β to the plane upper surface 19 of the substrate and thus at an angle to the cover 20. Due to the angle β, the distance over which the hose is in contact with the substrate 21 is longer, and the bonding between the substrate 21 and the hose 18 can be improved. The receiving cavity is drilled into the substrate and forms a bore hole with a first section 22 with a large cross-sectional size and a second section 23 with a relatively small cross-sectional size. The inner sealing member is moulded into the sealing well 24 and the outer sealing member is moulded into the sealing well 25. The bore hole extends into a groove which forms the inner chamber 26, and a connecting well 27 connects the second conduits with the outer chamber 28.

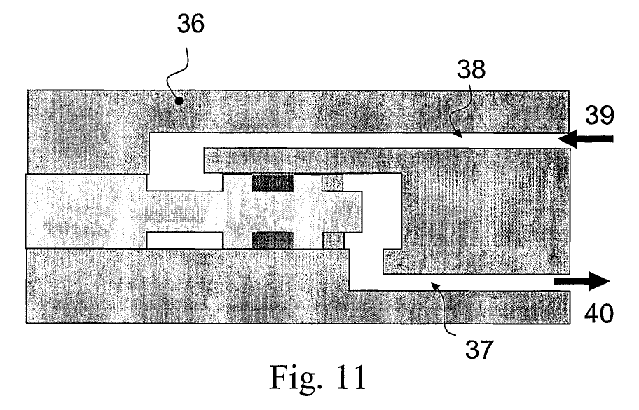

FIGS. 6-11 illustrate another embodiment of the device wherein the hose 29 comprises a proximal stripped off portion 30, a distal stripped off portion 31, and a stripped off free end 32. The inner sealing member 33 is located at the proximal stripped off portion 30, and the outer sealing member 34 is located on the opposite side of the distal stripped off portion 30. The inner sealing member thereby seals the second conduits in the portion of the hose which extends between the inner chamber and the outer chamber and thereby completely seals between the two chambers. The inner and outer sealing members 33, 34 are moulded through the openings in the cover 35. FIG. 8 is a cross sectional view of the device along line A in FIG. 7, FIG. 9 is a cross sectional view along line B and FIG. 10 is a cross sectional view along line C. FIG. 11 is a top view of the device without the cover. The upper surface 36 comprises grooves forming the inner and outer chamber 37, 38.

The arrows 39, 40 indicate a flow direction into the outer chamber and second conduits and out of the first conduit and inner chamber.

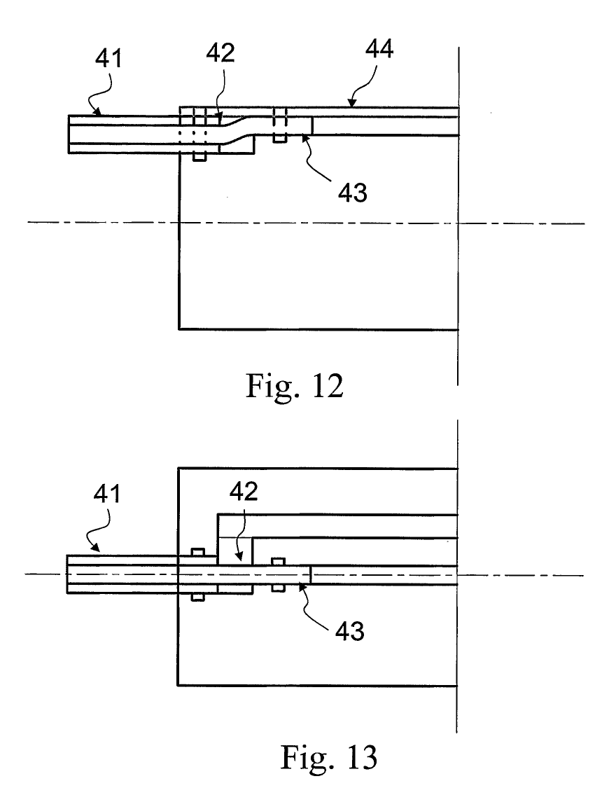

FIGS. 12 and 13 illustrate an embodiment wherein the hose 41 comprises a proximal stripped off portion 42 which is bend so that an end portion 43 thereof extends offset from the remaining part of the hose. The end portion 43 is offset approximately one half of the diametrical reduction of the stripped off portion. FIG. 13 is a top view of the device without the cover 44.

While the present invention has been illustrated and described with respect to a particular embodiment thereof, it should be appreciated by those of ordinary skill in the art that various modifications to this invention may be made without departing from the spirit and scope of the present invention.

What is claimed is:

1-13. (canceled)

14. A micro fluid device comprising a substrate with a channel forming a receiving cavity, an outer chamber, and an inner chamber, the device further comprising a multi lumen hose with a free end portion which is fixed in the receiving cavity, the multi lumen hose forming a first conduit and at least one second conduit, located offset from the first conduit, wherein the outer chamber is in fluid communication with at least one second conduit, and the inner chamber is in fluid communication with the first conduit and wherein the chambers are separated by an inner sealing member which seals between the substrate and the hose, wherein at least a part of the channel is formed by a groove in an upper surface of a body of the substrate, which groove closed by a cover which is sealed to the upper surface.

15. The device according to claim 14, wherein the outer chamber is separated from a surrounding space by an outer sealing member which seals between the substrate and the hose.

16. The device according to claim 14, wherein at least one of the sealing members extends through an opening in the cover into the receiving cavity.

17. The device according to claim 14, wherein at least one of the sealing members is fixed in a sealing well which forms part of the receiving cavity and which has a larger cross sectional size than parts of the receiving cavity on opposite sides of the sealing well.

18. The device according to claim 17, wherein each second conduit is formed by a peripheral outer portion of the hose which outer portion is at least partly removed in a distal stripped off portion of the hose.

19. The device according to claim 18, wherein the inner sealing member is located between distal stripped off portion and a free end of the hose.

20. The device according to claim 18, wherein the hose further comprises a proximal stripped off portions in which at least a part of the outer portion is removed to expose at least one of the second conduits.

21. The device according to claim 20, wherein the inner sealing member is located at the proximal stripped off portion and prevents passage through the exposed second conduits.

22. The device according to claim 14, wherein passage between the inner and outer chamber through the at least one second conduit is prevented by at least one internal sealing member located in each exposed second conduit.

23. The device according to claim 14, wherein the receiving cavity comprises in inner portion and an outer portion, the inner portion having a smaller cross sectional size than the outer portion.

24. The device according to claim 23, wherein the hose extends through the outer portion of the receiving cavity into the inner portion of the receiving cavity.

25. The device according to claim 14, wherein the hose extends at an angle different from zero degrees to a plane defined by the cover.

26. The device according to claim 25, wherein the body comprises a wall part which prevents further insertion of the hose into the receiving cavity.
